(19) United States
(12) Patent Application Publication
(10) Pub. No.: US 2008/0183824 A1
(43) Pub. Date: Jul. 31, 2008

(54) METHODS FOR DETACHING AN ATTACHMENT FILE FROM A CONTAINING EMAIL MESSAGE AND GENERATING METADATA ASSOCIATED WITH THE ATTACHMENT FILE AND THE CONTAINING EMAIL MESSAGE

(75) Inventors: Li Chen, Cary, NC (US); Yongcheng Li, Cary, NC (US); Yuping Wu, Cary, NC (US); Lun Xiao, Cary, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/668,138

(22) Filed: Jan. 29, 2007

(51) Int. Cl. G06F 15/16

(52) U.S. Cl. 709/206

(57) ABSTRACT

Methods for detaching an attachment file from a containing email message and generating metadata associated with the attachment file and the containing email message are provided. In one exemplary method, the method includes retrieving the containing email message from a server email application, utilizing a client email application. The method further includes storing the attachment file in the containing email message in a client memory device, and deleting the attachment file from the containing email message. The method further includes generating attachment file metadata and adding the attachment file metadata to the containing email message and storing the containing email message in a server memory device. The method further includes generating email metadata and storing the email metadata.

### FIELD OF INVENTION

This application relates to methods for detaching an attachment file of a containing email message and generating metadata associated with the attachment file and the containing email message.

### BACKGROUND OF INVENTION

An email application has been developed that allows a user to receive an email message with an attachment file. The email application also allows a user to detach the attachment file from the email message. However, a problem with the email application is that the application does not have any means of tracking the detached attachment file. Accordingly, when a user is subsequently viewing the email message, the user may have a difficulty in finding the location of the detached attachment file in order to view the contents of the attachment file. Further, the user cannot track the location of the email message from the location of the attachment file.

### SUMMARY OF INVENTION

A method for detaching an attachment file from a containing email message and generating metadata associated with the attachment file and the containing email message in accordance with an exemplary embodiment is provided. The method includes retrieving the containing email message from a server email application, utilizing a client email application. The method further includes displaying the containing email message on a graphical user interface, utilizing the client email application. The method further includes storing the attachment file in the containing email message in a client memory device, and deleting the attachment file from the containing email message. The method further includes generating attachment file metadata having an email identifier associated with the containing email message, an attachment file identifier associated with the attachment file, and a directory name indicating a location of the attachment file in the client memory device. The method further includes adding the attachment file metadata to the containing email message and storing the containing email message in a server memory device. The method further includes generating email metadata having the attachment file identifier associated with the attachment file and the directory name indicating the location of the attachment file in the client memory device and the email identifier associated with the containing email message.

A method for accessing an attachment file associated with a containing email message in accordance with another exemplary embodiment is provided. The method includes displaying a graphical user interface having the containing email message and a link to the attachment file associated with the containing email message. The link is generated utilizing attachment file metadata in the containing email message. The attachment file metadata has an attachment file identifier associated with the attachment file and a directory name indicating a location of the attachment file in the client memory device. The method further includes accessing the attachment file utilizing the link on the graphical user interface.

A method for accessing a containing email message associated with an attachment file in accordance with another exemplary embodiment is provided. The method includes displaying a graphical user interface having attachment file information associated with the attachment file and a link to the containing email message. The link is generated utilizing email metadata associated with the attachment file. The email metadata has an email identifier associated with the containing email message, an attachment file identifier associated with the attachment file, and a directory name indicating a location of the attachment file in a client memory device. The method further includes accessing the containing email message utilizing the link on the graphical user interface.

### BRIEF DESCRIPTION OF DRAWINGS

FIG. 1 is a block diagram of a system for detaching an attachment file from a containing email message and generating metadata associated with the attachment file and the containing email message in accordance with an exemplary embodiment;

FIGS. 2-3 are flowcharts of a method for generating attachment file metadata and email metadata in accordance with another exemplary embodiment;

FIG. 4 is a flowchart of a method for accessing an attachment file associated with a containing email message in accordance with another exemplary embodiment; and

FIG. 5 is a flowchart of a method for accessing a containing email message associated with an attachment file in accordance with another exemplary embodiment.

### DESCRIPTION OF EMBODIMENTS

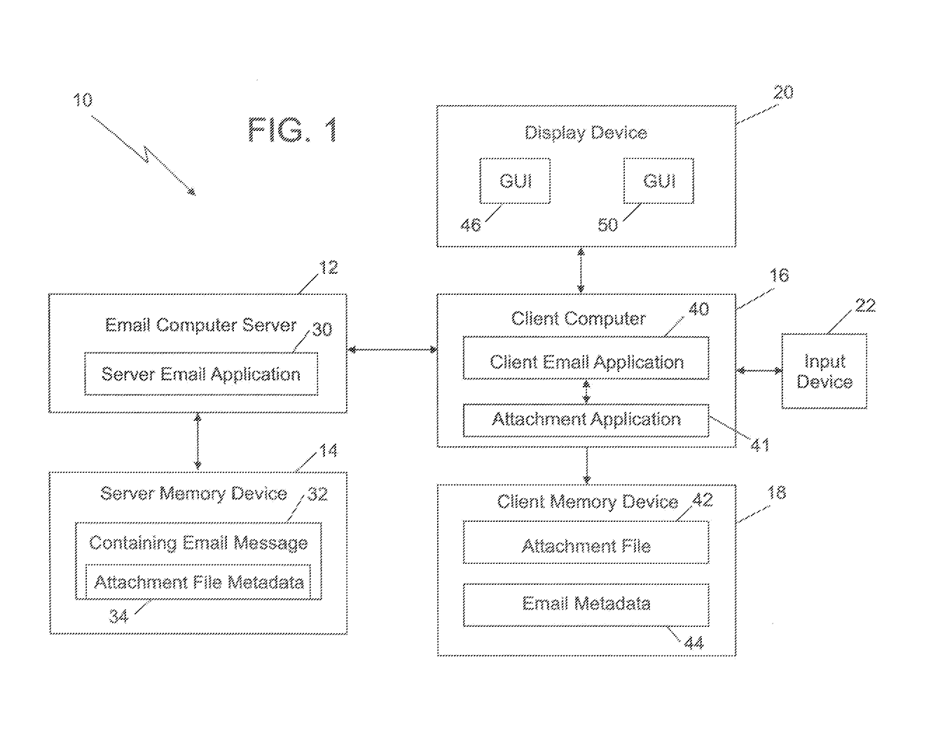

Referring to FIG. 1, a block diagram of a system 10 for detaching an attachment file from a containing email message and generating metadata associated with the attachment file and the containing email message in accordance with an exemplary embodiment is illustrated. It should be noted that the containing email message can contain one or more attachment files. The system 10 includes an email computer server 12, a server memory device 14, a client computer 16, a client memory device 18, a display device 20, and an input device 22.

The email computer server 12 is provided to receive containing email messages that initially have an attachment file contained therein. The email computer server 12 is configured to communicated with the server memory device 14 for storing a containing email message and attachment file metadata associated with an associated attachment file which will be explained in greater detail below. The email computer server 12 is further configured to communicated with the client computer 16. In particular, the server email application 30 executing on email computer server 12 is configured to communicate with the client email application 40 executing on the client computer 16.

The client email application 40 is provided to request a containing email message 32 from the server email application 30 that is stored in the server memory device 14. Further, the client email application 40 is configured to generate attachment file metadata 34 associated with an attachment file 42 in the containing email message 32 that is sent to the server email application 30 and stored in the server memory device 14. The attachment file metadata 34 includes: (i) a unique attachment file identifier associated with the attachment file 42, (ii) an attachment file name, (iii) a host name and/or IP address indicating a location where the attachment file 42 is stored in the client memory device 14, (iv) a virtual directory name indicating a location where the attachment file 42 is stored, (v) a time value indicating when the attachment file 42 is stored, and (vi) an email identifier identifying the containing email message 32. The client email application 40 is further configured to store the attachment file metadata 34 and the containing email message 32 in the server memory device 14. Further, the client email application 40 is further configured to generate email metadata 44 associated with the containing email message 32. The email metadata 44 includes: (i) a unique attachment file identifier associated with the attachment file, (ii) an attachment file name, (iii) an email computer server name and address, (iv) an email folder on an email computer server 12; (v) a title associated with the containing email message 32, (vii) a date indicating when the containing email message 32 was generated, (vii) an email sender identifier, (ix) a time value indicating a when the attachment file 42 was stored, (x) a virtual directory name indicating a virtual location where the attachment file 42 is stored, (xi) a physical directory name indicating a physical location were the attachment file 42 is to be stored on the client memory device 18, and (xii) an email identifier associated with the containing email message 32. The client email application 40 is further configured to store the email metadata in the client memory device 18. Further, the client email application 40 is configured to display the graphical user interfaces 46 and 50 on a display device 20, which will be explained in greater detail below.

The input device 22 is provided to allow a user to input selections that are received by the client email application 40. In one exemplary embodiment, the input device 22 is a computer mouse. In another exemplary embodiment, the input device 22 is a keyboard. Of course in alternative embodiments, any input device known to those skilled in the art could be utilized for the input device 22.

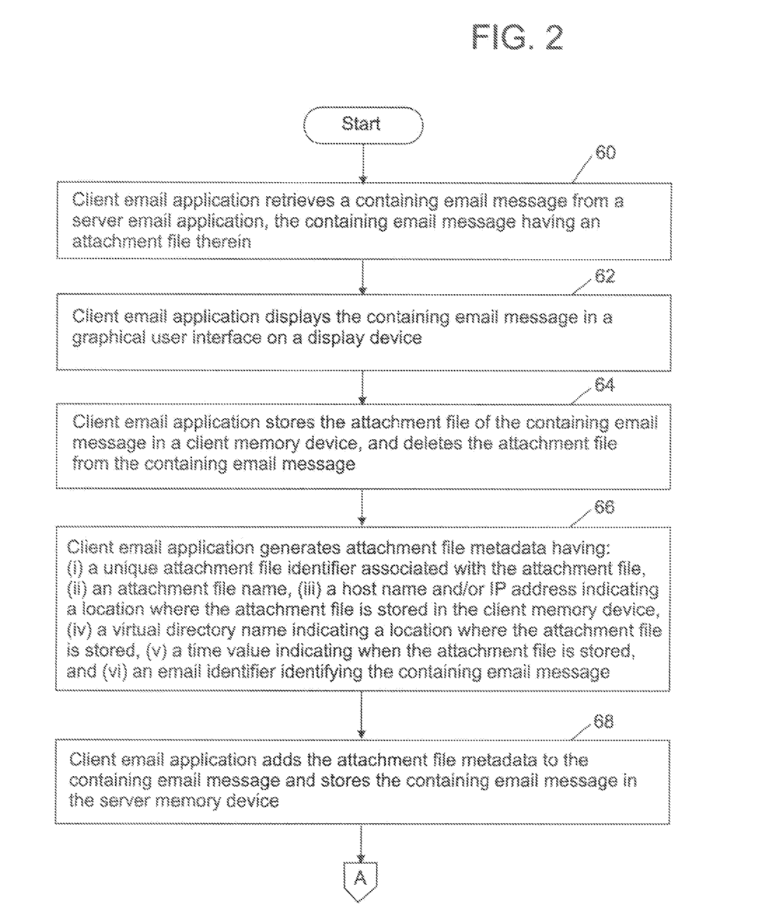

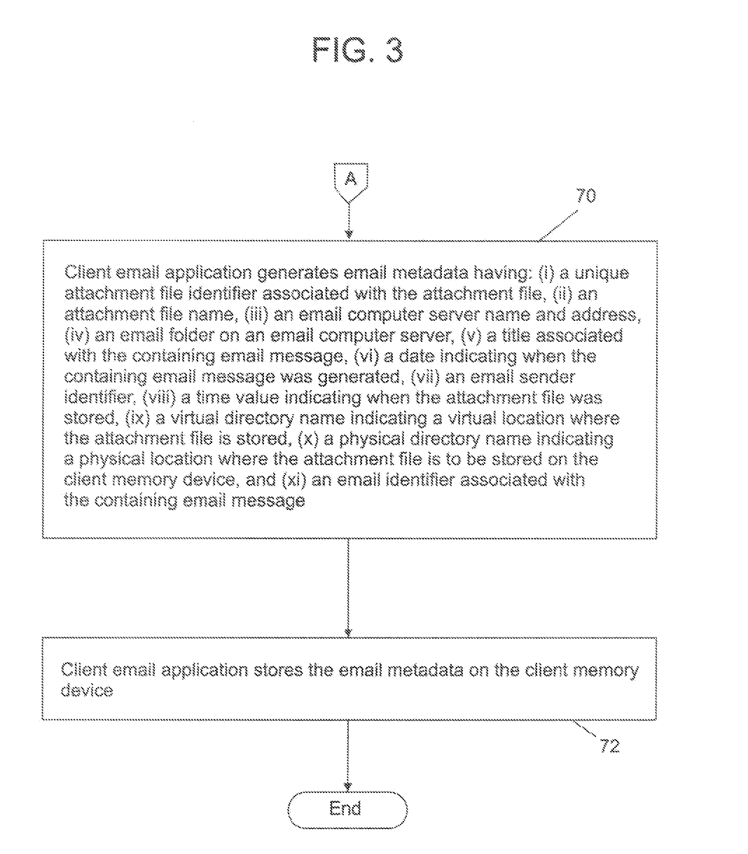

Referring to FIGS. 2-3, a flowchart of a method for detaching an attachment file from a containing email message and generating attachment file metadata and email metadata in accordance with an exemplary embodiment will now be explained.

At step 60, the client email application 40 retrieves the containing email message 32 from the server email application 30. The containing email message 32 initially has an attachment file 42 contained therein.

At step 62, the client email application 40 displays the containing email message 32 in the graphical user interface 46 on the display device 20.

At step 64, the client email application 40 stores the attachment file 42 of the containing email message 32 in the client memory device 18, and deletes the attachment file 42 from the containing email message 32.

At step 66, the client email application 40 generates attachment file metadata 34 having: (i) a unique attachment file identifier associated with the attachment file 42, (ii) an attachment file name, (iii) a host name and/or IP address indicating a location where the attachment file 42 is stored in the client memory device 18, (iv) a virtual directory name indicating a location where the attachment file 42 is stored, (v) a time value indicating when the attachment file 42 is stored, and (vi) an email identifier identifying the containing email message 32.

At step 68, the client email application 40 adds the attachment file metadata 34 to the containing email message 32 and stores the containing email message 32 in the server memory device 14.

At step 70, the client email application 40 generates email metadata 44 having: (i) a unique attachment file identifier associated with the attachment file 42, (ii) an attachment file name, (iii) an email computer server name and address, (iv) an email folder on an email computer server 12; (v) a title associated with the containing email message 32, (vi) a data indicating when the containing email message 32 was generated, (vii) an email sender identifier, (viii) a time value indicating when the attachment file 42 was stored, (ix) a virtual directory name indicating a virtual location where the attachment file 42 is stored, (x) a physical directory name indicating a physical location were the attachment file 42 is to be stored on the client memory device 18, and (xi) an email identifier associated with the containing email message 32.

At step 72, the client email application 40 stores the email metadata 44 on the client memory device 18.

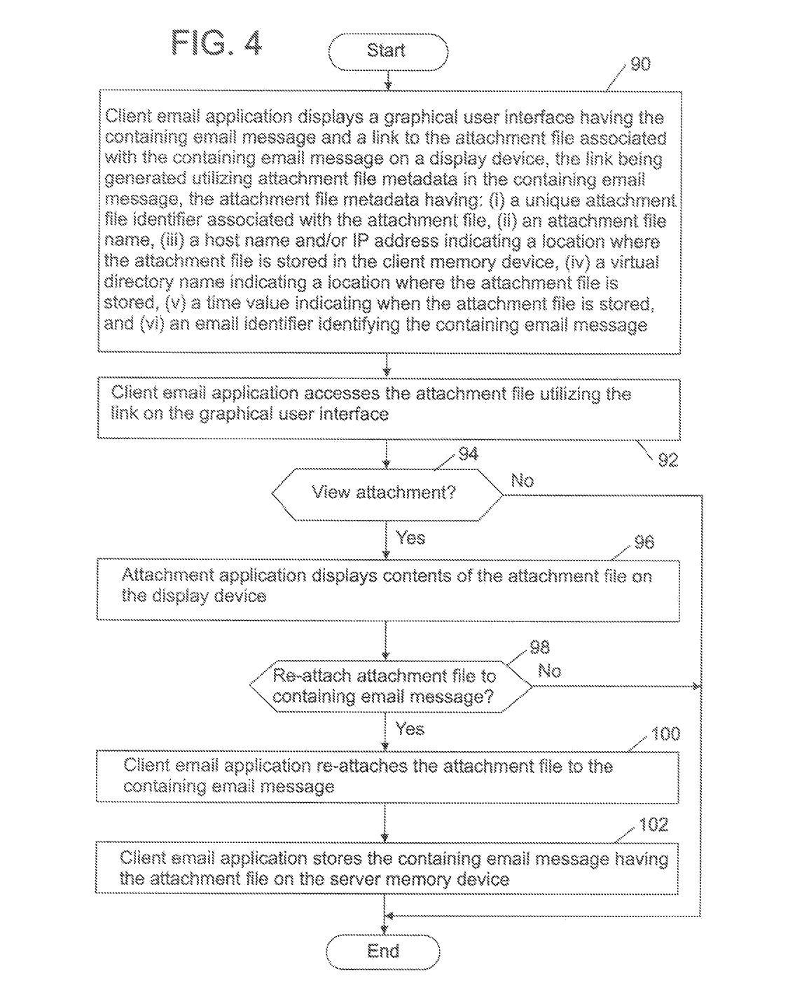

Referring to FIG. 4, a flowchart of a method for accessing an attachment file associated with a containing email message in accordance with another exemplary embodiment will now be described.

At step 90, the client email application 40 displays a graphical user interface 46 having the containing email message 32 and a link to the attachment file 42 associated with the containing email message 32 on the display device 20. The link is generated utilizing attachment file metadata 34 in the containing email message 32. The attachment file metadata 34 includes: (i) a unique attachment file identifier associated with the attachment file 42, (ii) an attachment file name, (iii) a host name and/or IP address indicating a location where the attachment file 42 is stored in the client memory device 18, (iv) a virtual directory name indicating a location where the attachment file 42 is stored, (v) a time value indicating when the attachment file 42 is stored, and (vi) an email identifier identifying the containing email message 32.

At step 92, the client email application 40 accesses the attachment file 42 utilizing the link on the graphical user interface 46.

At step 94, the client email application 40 makes a determination as to whether a user has selected to view the contents of the attachment file 42. The user selection can be made using the input device 22. If the value of step 94 equals “yes”, the method advances to step 96. Otherwise, the method is exited.

At step 96, an attachment application 41 displays contents of the attachment file 42 on the display device 20.

At step 98, the client email application 40 makes a determination as to whether the user has selected to re-attach attachment file 42 to the containing email message 32. The user selection can be made using the input device 22. If the value of step 98 equals “yes”, the method advances to step 100. Otherwise, the method is exited.

At step 100, the client email application 40 re-attaches the attachment file 42 to the containing email message 32.

At step 102, the client email application 40 stores the containing email message 32 having the attachment file 42 on the server memory device 14, via the email computer server 12. After step 102, the method is exited.

It should be noted the in an alternative method, the actions on the attachment file are not limited to the viewing the attachment file and re-attaching the attachment file to the containing email message.

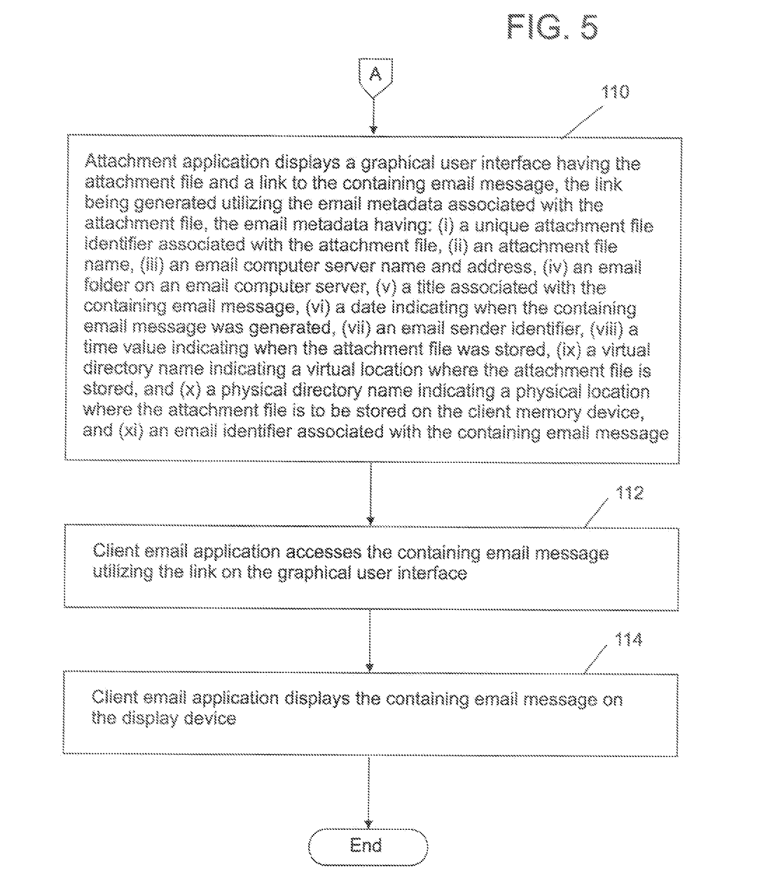

Referring to FIG. 5, a flowchart of a method for accessing a containing email message associated with an attachment file in accordance with another exemplary embodiment will not be explained.

At step 110, the attachment application 41 displays a graphical user interface 50 having the attachment file 42 and a link to the containing email message 32. The link is generated utilizing the email metadata 44 associated with the attachment file 42. The email metadata 44 includes: (i) a unique attachment file identifier associated with the attachment file 42, (ii) an attachment file name, (iii) an email computer server name and address, (iv) an email folder on an email computer server 12; (v) a title associated with the containing email message 32, (vi) a date indicating when the containing email message 32 was generated, (vii) an email sender identifier, (viii) a time value indicating when the attachment file 42 was stored, (ix) a virtual directory name indicating a virtual location where the attachment file 42 is stored, and (x) a physical directory name indicating a physical location were the attachment file 42 is to be stored on the client memory device 18, and (xi) an email identifier associated with the containing email message 32.

At step 112, the client email application 40 accesses the containing email message 32 utilizing the link on the graphical user interface 50.

At step 114, the client email application 40 displays the containing email message 32 on the display device 20. After step 114, the method is exited.

The methods for detaching an attachment file from a containing email message and generating metadata associated with the attachment file and the containing email message provide a substantial advantage over other methods. In particular, the method provides a technical effect of generating attachment file metadata such that a detached attachment file can be readily assessed by user while viewing a containing email message.

While the invention is described with reference to an exemplary embodiment, it will be understood by those skilled in the art that various changes may be made and equivalent elements may be substituted for elements thereof without departing from the scope of the invention. In addition, many modifications may be made to the teachings of the invention to adapt to a particular situation without departing from the scope thereof. Therefore, it is intended that the invention not be limited the embodiment disclosed for carrying out this invention, but that the invention includes all embodiments falling with the scope of the appended claims. Moreover, the use of the term's first, second, etc. does not denote any order of importance, but rather the term's first, second, etc. are used to distinguish one element from another.

We claim:

1. A method for detaching an attachment file from a containing email message and generating metadata associated with the attachment file and the containing email message, comprising:
retrieving the containing email message from a server email application, utilizing a client email application;
displaying the containing email message on a graphical user interface, utilizing the client email application;
storing the attachment file in the containing email message in a client memory device, and deleting the attachment file from the containing email message;
generating attachment file metadata having an email identifier associated with the containing email message, an attachment file identifier associated with the attachment file, and a directory name indicating a location of the attachment file in the client memory device;
adding the attachment file metadata to the containing email message and storing the containing email message in a server memory device; and
generating email metadata having the attachment file identifier associated with the attachment file and the directory name indicating the location of the attachment file in the client memory device and the email identifier associated with the containing email message.

2. A method for accessing an attachment file associated with a containing email message, the method comprising:
displaying a graphical user interface having the containing email message and a link to the attachment file associated with the containing email message, the link being generated utilizing attachment file metadata in the containing email message, the attachment file metadata having an attachment file identifier associated with the attachment file and a directory name indicating a location of the attachment file in the client memory device; and
accessing the attachment file utilizing the link on the graphical user interface.

3. A method for accessing a containing email message associated with an attachment file, the method comprising:
displaying a graphical user interface having attachment file information associated with the attachment file and a link to the containing email message, the link being generated utilizing email metadata associated with the attachment file, the email metadata having an email identifier associated with the containing email message, an attachment file identifier associated with the attachment file, and a directory name indicating a location of the attachment file in a client memory device; and
accessing the containing email message utilizing the link on the graphical user interface.
